(19) United States
(12) Patent Application Publication
(10) Pub. No.: US 2014/0201974 A1
(43) Pub. Date: Jul. 24, 2014

(54) METHOD OF REMOVING A WRENCHING MEANS FROM A BLIND FASTENER

(71) Applicant: Monogram Aerospace Fasteners, Inc., Los Angeles, CA (US)

(72) Inventor: James Mitchell, Downey, CA (US)

(21) Appl. No.: 14/219,052

(22) Filed: Mar. 19, 2014

Related U.S. Application Data
(63) Continuation of application No. PCT/US2012/056031, filed on Sep. 19, 2012.
(60) Provisional application No. 61/536,278, filed on Sep. 19, 2011.
(60) Provisional application No. 61/536,283, filed on Sep. 19, 2011.

(51) Int. Cl. B21J 15/04; B23P 17/02

(52) U.S. Cl. CPC B21J 15/04; B23P 17/02
USPC 29/524.1; 29/557

(57) ABSTRACT

Disclosed is a method of dressing an installed blind fastener that includes machining through a top surface of the fastener along a longitudinal axis of a core bolt of the fastener and an extension that extends from a body of the fastener until intersecting the undercut between the extension and an upper surface of the fastener to remove the extension.

### CROSS REFERENCE TO RELATED APPLICATIONS

This application is a continuation of International Application No. PCT/US2012/056031, filed Sep. 19, 2012, which claims the benefit U.S. Provisional Application No. 61/536,278, filed Sep. 19, 2011 and U.S. Provisional Application No. 61/536,283, filed Sep. 19, 2011, which are incorporated by reference in their entirety.

### BACKGROUND

In many applications, exterior aircraft surfaces should be aerodynamically smooth and aesthetically pleasing. Current (conventional) assembly processes typically utilize two-sided fasteners such as solid rivets, lock bolts with collars, and threaded pins with nuts. The manufactured heads of these installed fasteners are often positioned on the airflow surfaces of the aircraft. Their construction means that the exposed surface(s) can be easily painted with acceptable results because of the absence of head surface discontinuities.

Blind fasteners are desirable for airframe assembly, because their installation can be more easily automated than the installation of conventional bolts and nuts. However, some existing blind fasteners leave exterior surfaces that are not aerodynamically smooth.

In addition, many applications specify a minimum installed seated torque for fasteners to ensure adequate fastener performance. In some applications it is necessary to verify that each installed fastener meets the required minimum installed seated torque requirement for the particular application to ensure adequate fastener performance.

Newer generation aircraft are frequently assembled robotically, and it is often not practical to install conventional two-sided fasteners such as solid rivets, lock bolts and threaded pins with this type of equipment. The primary issue with robotic assembly is the equipment cost and programming coordination. The requisite equipment is essentially doubled (compared to single-sided applications) due to requiring equipment on each side so as to have access to each end of the fastener.

As a result, a need exists for blind (one-sided) fasteners that are easily installed with a robot. In addition, a means to verify that the minimum required seated torque is achieved with each fastener is desirable. Additionally, the fastener having a finished head surface that may be painted with a good quality finish is also desirable. The present disclosure relates to a removable wrenching means for a threaded blind fastener that may produce a machineable and paintable exposed head surface. The present disclosure also relates to a threaded blind fastener that is constructed and arranged to allow verification of meeting minimum seated torque applications requirements.

### BRIEF DESCRIPTION OF THE DRAWINGS

FIG. 1 is a perspective view of a blind fastener according to one embodiment of the present disclosure.

FIG. 2 is a front elevational view of the FIG. 1 blind fastener.

FIG. 3 is a front elevational view, in full section, of the FIG. 1 blind fastener, as viewed along line 3-3 in FIG. 2.

FIG. 4 is a front elevational view of the FIG. 1 blind fastener, as seated fastening work pieces together.

FIG. 5 is a front elevational view, in full section, of the FIG. 4 seated fastener as viewed along line 5-5 in FIG. 4.

FIG. 6 is a front elevational view of the FIG. 1 blind fastener seated fastening work pieces together with the wrenching means being removed by a flat-bottom cutting tool.

FIG. 7 is a front elevational view of the FIG. 1 blind fastener, as installed, after removal of the wrenching means but prior to finishing.

FIG. 8 is a front elevational view, in full section, of the FIG. 7 installed fastener, as viewed along line 8-8 in FIG. 6.

FIG. 9 is a front elevational view of the FIG. 1 blind fastener, as installed and finished.

FIG. 10 is a front elevational view, in full section, of the FIG. 9 finished fastener, as viewed along line 10-10 in FIG. 9.

FIG. 11 is a partial, perspective view of the FIG. 9 finished installation.

FIG. 12 is a front elevational view of an alternative embodiment of a blind fastener, as seated, according to the present disclosure.

FIG. 13 is a front elevational view, in full section, of the FIG. 12 blind fastener as viewed along line 13-13 in FIG. 12.

FIG. 14 is a front elevational view of yet another alternative embodiment of a blind fastener, as seated, according to the present disclosure.

FIG. 15 is a front elevational view, in full section, of the FIG. 14 blind fastener as viewed along line 15-15 in FIG. 14.

FIG. 16 is a front elevational view of still another alternative embodiment of a blind fastener, as seated, according to the present disclosure.

FIG. 17 is a front elevational view, in full section, of the FIG. 16 blind fastener as viewed along line 17-17 in FIG. 16.

FIG. 18 is a front elevational view of still another alternative embodiment of a blind fastener, as seated, according to the present disclosure.

FIG. 19 is a front elevational view, in full section, of the FIG. 18 blind fastener as viewed along line 19-19 in FIG. 18.

### DETAILED DESCRIPTION OF THE DRAWINGS

For the purpose of promoting an understanding of the disclosure, reference will now be made to certain embodiments thereof and specific language will be used to describe the same. It will nevertheless be understood that no limitation of the scope of this disclosure is thereby intended, such alterations, further modifications and further applications of the principles described herein being contemplated as would normally occur to one skilled in the art to which the disclosure relates. In several FIGs., where there are the same or similar elements, those elements are designated with similar reference numerals.

Disclosed herein is a clamp portion incorporated in a blind fastener that is deformable from a shape that fits through an aperture to an enlarged flanged shape that provides a clamping surface on the blind side of the aperture the clamp previously passed through. The terms “bulb,” “bulbed,” and “bulbing” are used herein to describe the deformation process and the result of that process where the outer diameter of the deformable portion swells upon application of a compressive load that deforms and/or buckles the deformable clamp portion in a predetermined fashion to form the desired blind side clamping surface to complete the installation. Several different types of blind fasteners are disclosed herein and the claims refer to this type of fastener in a generic sense in the context of the rest of the claim.

It should be understood that “wrenching portions,” “wrenching surfaces, ” “wrenching feature,” “wrenching flats” and “engaging means,” as used herein, are intended to indicate a feature that can be engaged with a manual or automatic tool, including a cylindrical surface engageable by a one-way clutch or roller clutch. The fasteners disclosed herein can be used in both manual and automated applications. Use of cylindrical surfaces instead of wrenching flats makes it easier to use various fasteners with automated installation robots. Conversely, in manual applications, human operators are adapt at adjusting parts as required to fit geometric wrenches, and geometric wrench apparatuses are generally less expensive than one-way clutches. Accordingly, other applications lend themselves to the use of conventional wrenching surfaces.

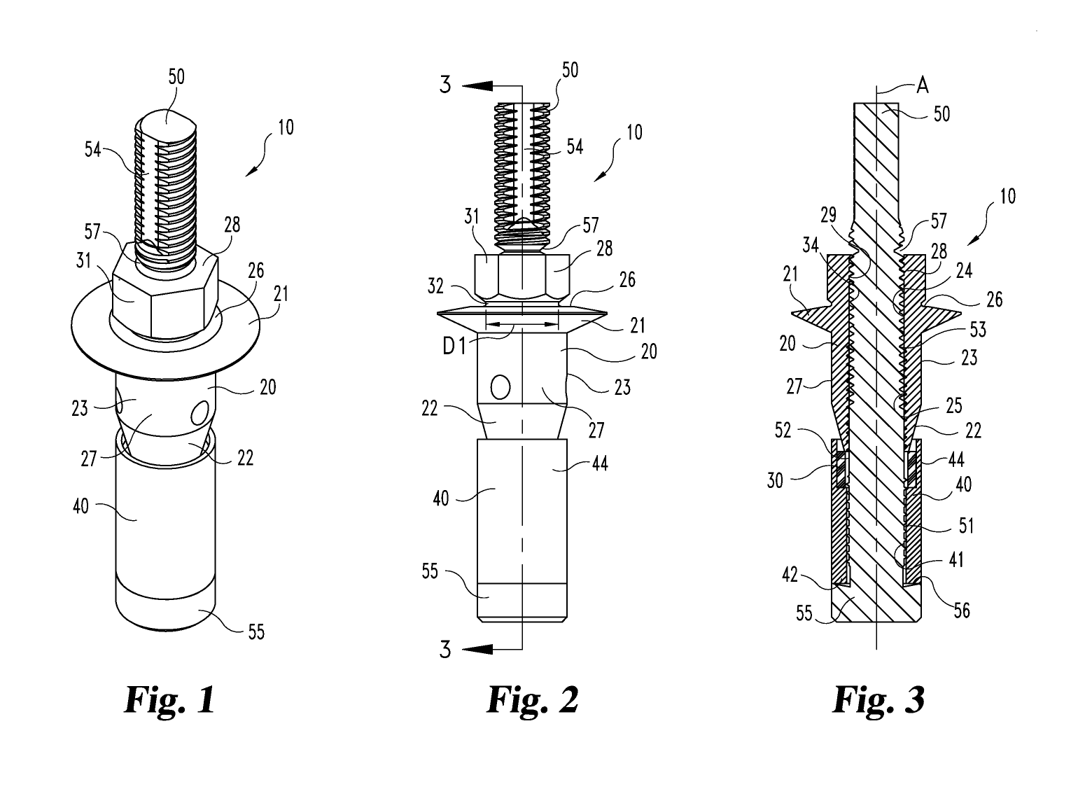

Referring now to FIGS. 1-3, blind fastener 10 is illustrated including body 20, deformable sleeve 40 and core bolt 50. Longitudinal axis A is the longitudinal axis of blind fastener 10, body 20 and core bolt 50. Core bolt 50 includes enlarged head 55 at one end, engaging means 54 at the opposite end, first threaded portion 51, second threaded portion 53 and shank 52. First threaded portion 51 is an externally threaded portion with threads truncated to the pitch diameter as illustrated. However, in some embodiments, first threaded portion 51 could have full threads. Shank 52 is generally cylindrical in shape and may have a substantially smooth surface finish. Second threaded portion 53 is externally threaded with full threads. However, in some embodiments, second threaded portion 53 could be threaded with crest truncation to the pitch diameter. Both first and second threaded portions 51 and 53 may be threaded at the same pitch diameter.

Body 20 includes enlarged head 21, conical nose 22, a generally cylindrical shank 23, smooth wall bore 24, internally threaded bore 25, upper surface 26, outer surface 27, extension 28 extending therefrom with extension threads 29 and wrenching surfaces 31 on extension 28 and undercut 32. Enlarged head 21 may have a frustoconical shape that may be constructed and arranged to correspond to a countersink shape. Upper surface 26 may be slightly domed (convex), or raised. Smooth wall bore 24 may be a cylindrical form that is sized for a close fit around (unthreaded) shank 52.

Deformable sleeve 40 includes lower end 42 and deformable portion 44. Deformable sleeve 40 defines through bore 41.

Enlarged head 55 of the core bolt 50 includes a shoulder 56 that seats (i.e., abuts against) the lower end 42 of deformable sleeve 40. Accordingly, as core bolt 50 is drawn upwardly, deformable sleeve 40 is pulled up the outer surface 27 of body 20 starting with the conical nose 22. As described below this results in the deformation of deformable portion 44 to form a blind side clamp that can be drawn against a work piece to clamp that work piece.

Shank 52 is positioned between the upper and lower sets of threads, the second threaded portion 53 and first threaded portion 51, respectively. Shank 52 optionally may include annular groove 57 that extends around core bolt 50 that creates a frangible location for separating the top portion (as oriented in the drawings) of core bolt 50, including engaging means 54, from the bottom portion of core bolt 50, including enlarged head 55, as will be described below. Annular groove 57, like undercut 32, may be configured to fracture upon application of a predetermined fracturing torque, such as when a desired clamping load is achieved during installation of fastener 10, as described below.

Undercut 32 may be located at the base of extension 28 between wrenching surfaces 31 and upper surface 26. Undercut 32 is constructed as a narrowed region between body 20 and extension 28 that has an outside diameter D1. Undercut 32 may optionally define a frangible region between body 20 and extension 28. Extension threads 29 may include root truncation to the pitch diameter while internally threaded bore 25 may have internal threads with crest truncation to the pitch diameter. As such, internally threaded bore 25 may be constructed and arranged to not threadingly engage second threaded portion 53 while extension threads 29 may be constructed and arranged to threadingly engage second threaded portion 53. Undercut 32 may be constructed and arranged to allow the removal of extension 28 by drilling out bore 34 and/or extension threads 29 after the installation of fastener 10 as described below.

Alternatively, or in addition, undercut 32 may be constructed and arranged to fracture upon application of a specified fracturing torque. Fastener 10 may be configured to achieve an application specified minimum installed seated torque defined by the intended use of fastener 10. The minimum installed seated torque may correspond to a desired clamping load being imparted by fastener 10 to the work pieces. The actual specified minimum installed seated torque for a particular fastener 10 may be defined by an end user or by performance standards for a particular application. Furthermore, fastener 10 may be constructed using particular manufacturing standards that result in a manufacturing failure torque tolerance for a particular standard for constructing undercut 32. The manufacturing failure torque tolerance for a particular fastener 10 may be defined by standard statistical process control methodologies well known to those skilled in the art. Each particular fastener 10 may be constructed with a specified fracturing torque equal to the sum of the minimum installed seated torque for the intended application and the manufacturing failure torque tolerance determined by the method of manufacturing the particular fastener 10.

For example, a particular fastener 10 is intended for use in an application requiring 20 Newton-meters (N-m) minimum seated torque. The manufacturing method for the particular fastener 10 results in a manufacturing failure torque tolerance of 3 N-m (the difference between the minimum and maximum failure torque produced by the manufacturing method at a particular failure torque target). The specified fracturing torque for the particular fastener 10 in this example equals 23 N-m, the sum of 20 N-m and 3 N-m.

In use, applying torque to wrenching surfaces 31 after fastener 10 is installed (annular groove 57 has been fractured and a clamping load is being imparted by fastener 10) can be used to verify whether the application specified minimum installed seated torque is achieved for a particular installation. If undercut 32 fractures, then the application specified minimum installed seated torque was achieved. If fastener 10 rotates in the installation, then the application specified minimum installed seated torque may not have been achieved, indicating that the seated fastener should be removed and replaced.

Smooth wall bore 24 is located between internally threaded bore 25 and extension threads 29 inside of and in a region proximate to undercut 32. As illustrated, smooth wall bore 24 may optionally extend through a portion of extension 28. Extension threads 29 may be positioned distally from upper surface 26. The illustrated configuration provides space for shank 52 to extend to or through upper surface 26 without interference from extension threads 29. Extension threads 29 keep internally threaded bore 25 rotationally aligned with first threaded portion 51 preventing cross threading when body 20 reaches first threaded portion 51 and internally threaded bore 25 becomes threadingly engaged with first threaded portion 51.

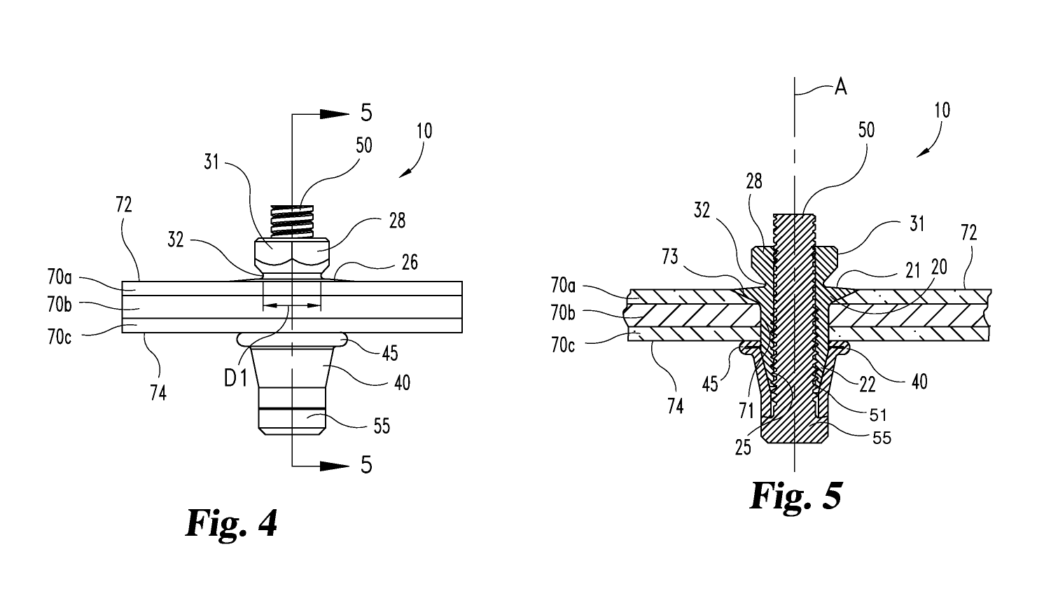

Referring to FIGS. 4 and 5, fastener 10 is shown installed through a plurality of work pieces 70a, 70b, and 70c and is clamping these work pieces together. While three work piece layers (laminations) are illustrated, it should be understood that a lesser number (2) or a greater number can be secured together by fastener 10 as described and illustrated herein. The referenced work pieces 70a-70c are composite laminations consistent with what may be expected or anticipated for the aircraft industry, but could also be metal panels or work pieces. The form of fastener 10 in FIGS. 4 and 5 is after the initial installation steps as further described hereinafter.

The preparation of the work pieces 70a-70c for receipt of blind fastener 10 includes first drilling a cylindrical bore 71 through the three work pieces and then finishing the outer surface 72 of work piece 70a with countersink 73. Into this prepared aperture, the fastener 10 is installed from the accessible side (on the side of outer surface 72) such that enlarged head 55 extends beyond blind side surface 74 of work piece 70c with enlarged head 21 seated into countersink 73.

The installation of FIGS. 4 and 5 is accomplished by rotationally threading the core bolt 50 into extension 28, with the enlarged head 55 of core bolt 50 forcing the deformable sleeve 40 up the conical nose 22 of body 20. This results in deformable portion 44 being compressed between blind side surface 74 and enlarged head 55, resulting in deformable portion 44 buckling and forming flange 45. In the context of this disclosure, deformable portion 44 is a clamp portion and flange 45 is an enlarged blind side clamp surface. In general, the relative rotational position of body 20 may be secured via engagement of wrenching surfaces 31 while core bolt 50 is rotated via engagement with engaging means 54 (see FIGS. 1-3). If not initially in threaded engagement, the first threaded portion 51 and threaded bore 25 come into engagement during the early stages of the installation cycle. The work pieces 70a-70c become tightly clamped together as the deformable sleeve 40 comes to bear against blind side surface 74, whereupon the engaging means 54 optionally separates from the core bolt at annular groove 57 (see FIGS. 1-3) as the torsion strength of the core bolt material is exceeded. The movement of deformable sleeve 40 into this bulbed configuration may be facilitated by use of an insert 30 that can be made of plastic, for example. These actions and interactions relative to deformable sleeve 40 and insert 30 are further explained in part in U.S. Pat. No. 4,457,652.

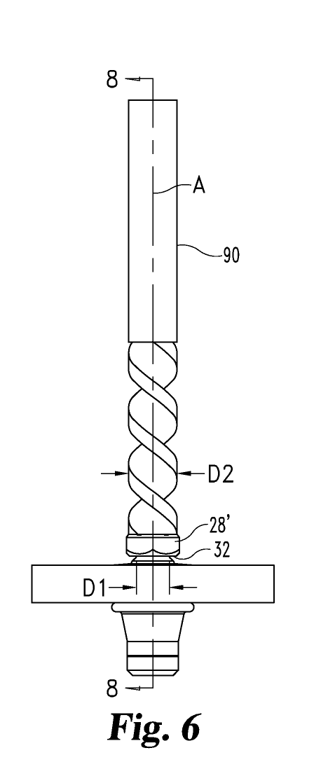

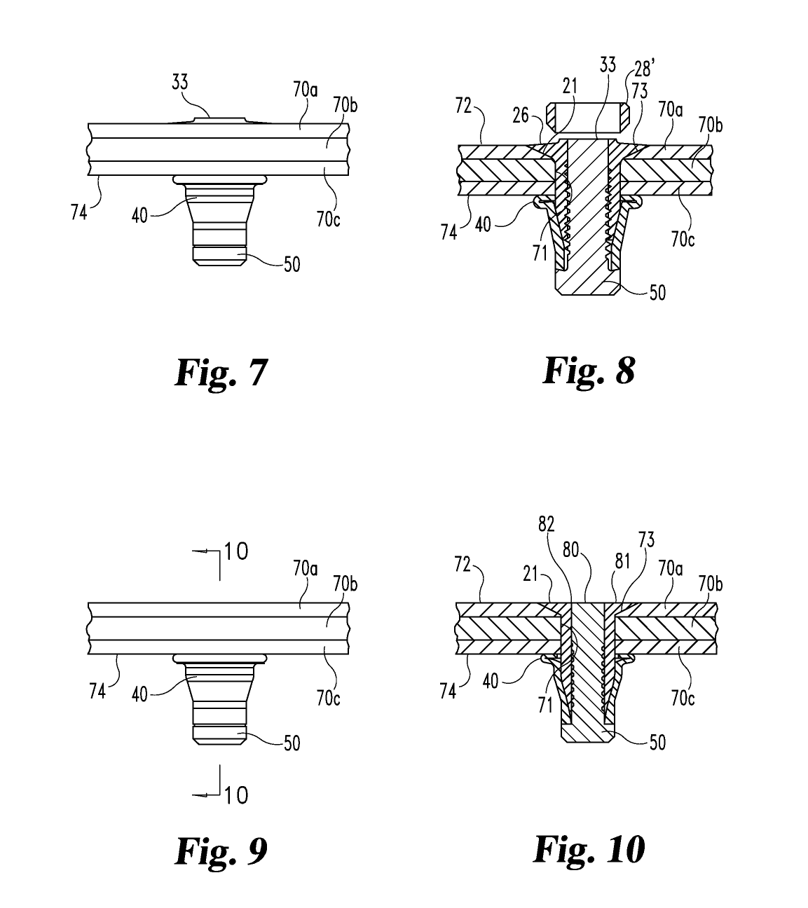

After work pieces 70a-70c are tightly clamped together (desired clamping load applied), the installation can optionally be verified using wrenching surfaces 31. Specifically, gradually increasing torque amounts may be applied to wrenching surfaces 31 (which are resisted solely by the clamping force generated by fastener 10 on work pieces 70a-70c) until either undercut 32 fractures thereby separating extension 28 from upper surface 26, indicating a proper or desired clamping load being imparted by fastener 10, or fastener 10 and extension 28 rotate relative to work pieces 70a-70c, indicating an improper clamping load being imparted by fastener 10. The fracturing of undercut 32 is illustrated in FIGS. 6 and 7 which show torn material 33 on the top of upper surface 26 where undercut 32 fractured and extension 28 separated from body 20.

After optional verification of a complete installation, for example, application of a specified torque amount through engaging means 54 as indicated by a torque wrench or by the fracture of groove 57, fastener 10 may be finished substantially flush with outer surface 72. An alternative first step in this process (when undercut 32 is not fractured to verify installation) is machining out the portions of core bolt 50 and extension 28. This is illustrated in FIG. 6 that illustrates cutting tool 90 machining along longitudinal axis A through extension 28 can bolt 50. Cutting tool 90 has an outer diameter D2 and optionally includes a flat-bottom cutting surface (not illustrated). Outer diameter D2 is optionally larger than outer diameter D1. Machining through the length of extension 28, centered on longitudinal axis A, until cutting tool 90 intersects undercut 32 separates remainder portion 28′ of extension 28 from fastener 10 leaving machined surface 33 and upper surface 26 as shown in FIGS. 7 and 8.

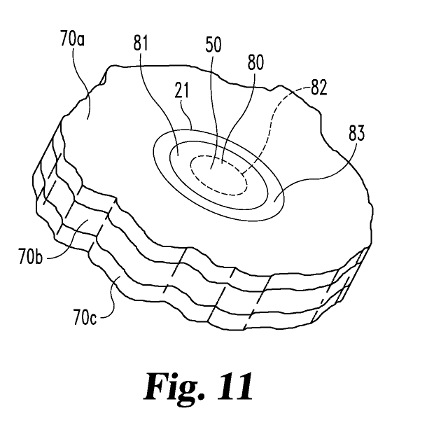

Referring now to FIGS. 9 and 10, after extension 28 is removed, either by fracturing undercut 32 or by machining along longitudinal axis A, the exposed upper surface 26 on enlarged head 21 of the body 20 may be shaved substantially flush with the outer surface 72 of work piece 70a to provide an aerodynamically smooth finished surface 81. Additional portions of core bolt 50 are also removed during this shaving step to provide a flush head 80. Upper surface 26 may define a dome of excess material on enlarged head 21 for shaving to avoid having to weaken the fastener 10 by excessive material removal. Further, the fastener body may be colored or dyed such that, after shaving flush the enlarged head 21, a band 83 of color on the periphery of the exposed head is visible (see FIG. 11). This annular ring of color may serve as an indicator as to how much material remains that can be safely removed.

One of the considerations in shaving off material to create a flush finish is that the fastener not be weakened by removing too much material. When an annular ring of color or surface finish is left, this can be visually inspected as a way to confirm that the fastener 10 has not been weakened, due to excess material removal. Further, since the shank 52 may be sized to be a close fit, ideally line-to-line, with bore 24, there is only a negligible discontinuity 82 at most between the core bolt 50 and the shaved surface of enlarged head 21. Accordingly, in those applications where the fastener is to be painted, this negligible discontinuity 82 is not exaggerated by the application of paint. The result is an aesthetically pleasing, flush-mounted, paintable blind fastener that is suitable for aircraft applications and robotic installation including optional automatic verification (via fracturing of undercut 32) of achieved application specified minimum installed seated torque.

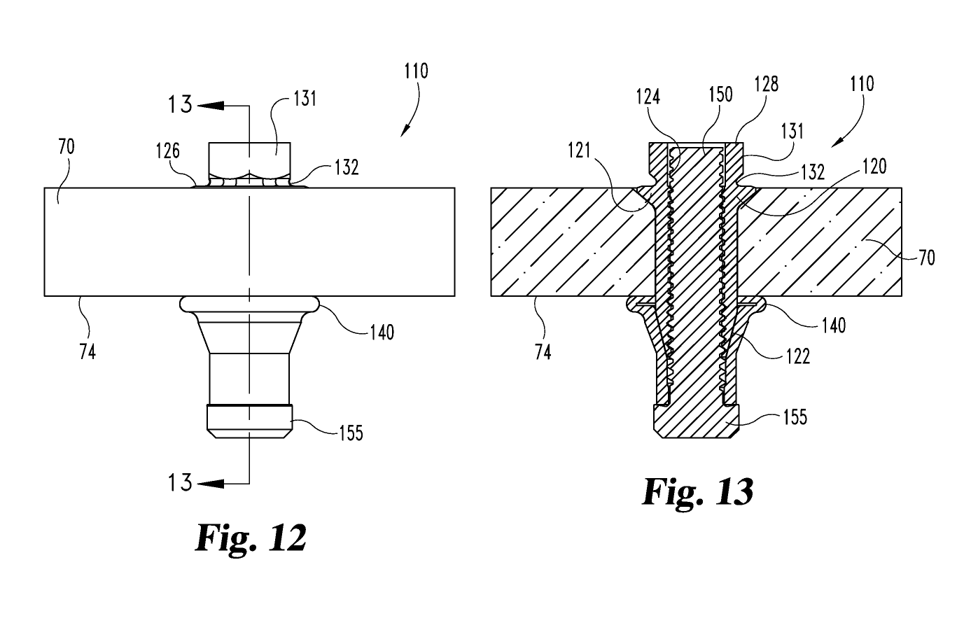

Referring now to FIGS. 12-13, blind fastener 110 is illustrated including body 120, deformable sleeve 140 and core bolt 150. Core bolt 150 includes enlarged head 155 at one end. Body 120 includes enlarged head 121, conical nose 122, smooth wall bore 124, upper surface 126, extension 128 extending therefrom with wrenching surfaces 131 on extension 128 and undercut 132. Enlarged head 121 may have a frustoconical shape that is constructed and arranged to correspond to a countersink shape. Upper surface 126 may be slightly domed (convex), or raised.

Blind fastener 110 operates similarly to blind fastener 10 although it is not necessary for extension 128 to be threadingly engaged with core bolt 150 (although it may be if so desired). Blind fastener 110 is illustrated in a seated state where deformable sleeve 140 has been deformed over conical nose 122 to form an enlarged flange against blind side surface 74 and applying a clamping load thereon.

Undercut 132 is located at the base of extension 128 between wrenching surfaces 131 and upper surface 126. Undercut 132 may be constructed and arranged in the same way described above with regard to undercut 32 to permit machining out the core of extension 128. Alternatively, the seated torque of fastener 110 may be verifiable by applying torque to wrenching surface 31 to fracture break groove 132. If break groove 132 fractures, then the application specified minimum installed seated torque was achieved. If fastener 110 rotates, then the application specified minimum installed seated torque may not have been achieved, indicating that the seated fastener should be removed and replaced.

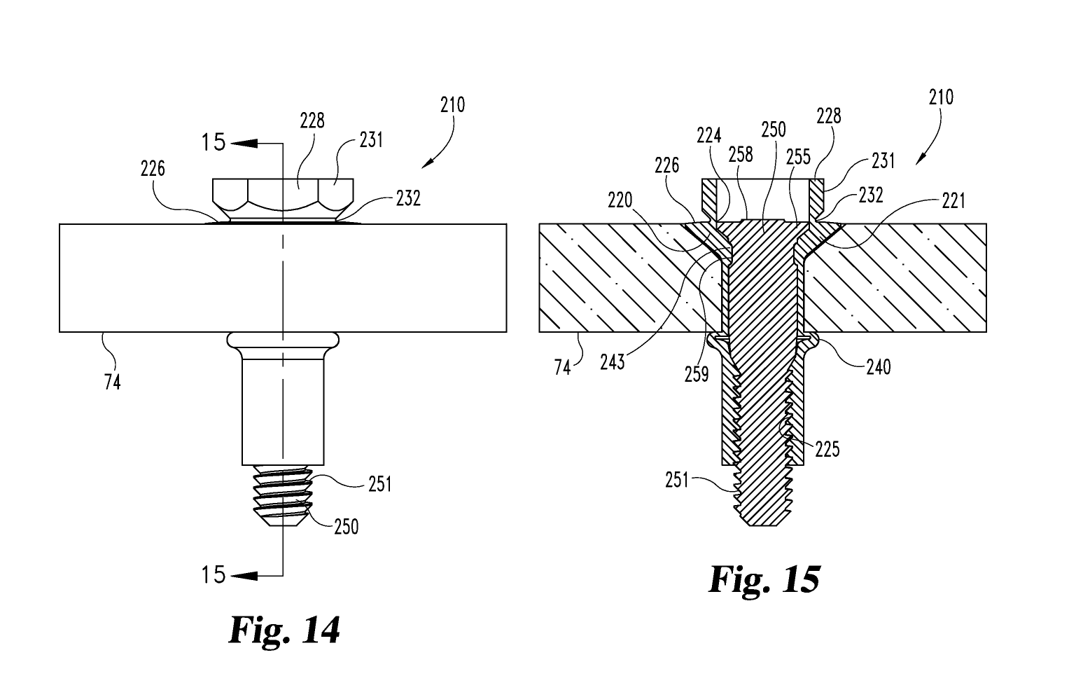

Referring now to FIGS. 14 and 15, blind fastener 210 is illustrated including body 220 and core bolt 250. Core bolt 250 includes enlarged head 255 at one end and externally threaded portion 251 at the opposite end. Enlarged head 255 includes engaging means 258. Engaging means 258 optionally comprises wrenching means attached by a break groove (not illustrated or detached), a recessed engaging surface such as a screw or Allen™ recess (not illustrated) or any other means known in the art to secure and rotate core bolt 250.

Body 220 includes enlarged head 221, smooth wall bore 224, deformable portion 240, internally threaded portion 225, upper surface 226 and undercut 232. Enlarged head 221 includes upper surface 226 and extension 228 extending therefrom with wrenching surface 231 on extension 228 and undercut 232 positioned between wrenching surfaces 231 and upper surface 226. Enlarged head 221 may have a frustoconical shape that is constructed and arranged to correspond to a countersink shape.

Core bolt 250 may optionally include recess 259 and body 220 may optionally include protrusion 243 extending into recess 259 to lock core bolt 250 and body 220 together (longitudinally locked, not rotationally).

Blind fastener 210 operates by securing the relative position of body 220 by grasping wrenching surface 231 then rotating core bolt 250 via engaging means 258 to deform deformable portion 240 against blind side surface 74. Optionally, the installed seated torque of blind fastener 210 may be tested by engaging wrenching surface 231 and applying torque until either break groove 232 fractures or fastener 210 rotates in the aperture.

Similar to break groove 32, break groove 232 may be constructed and arranged to fracture upon application of a specified fracturing torque which is equal to the sum of the minimum installed seated torque for the intended application and the manufacturing failure torque tolerance determined by the method of manufacturing a particular fastener 210. If fastener 210 rotates while attempting to fracture break groove 232 then the application specified minimum installed seated torque may not have been achieved indicating that the seated fastener 210 should be removed and replaced.

Undercut 232 is located at the base of extension 228 between wrenching surfaces 231 and upper surface 226. Undercut 232 may be constructed and arranged in the same way described above with regard to undercut 32 to permit machining out the core of extension 228.

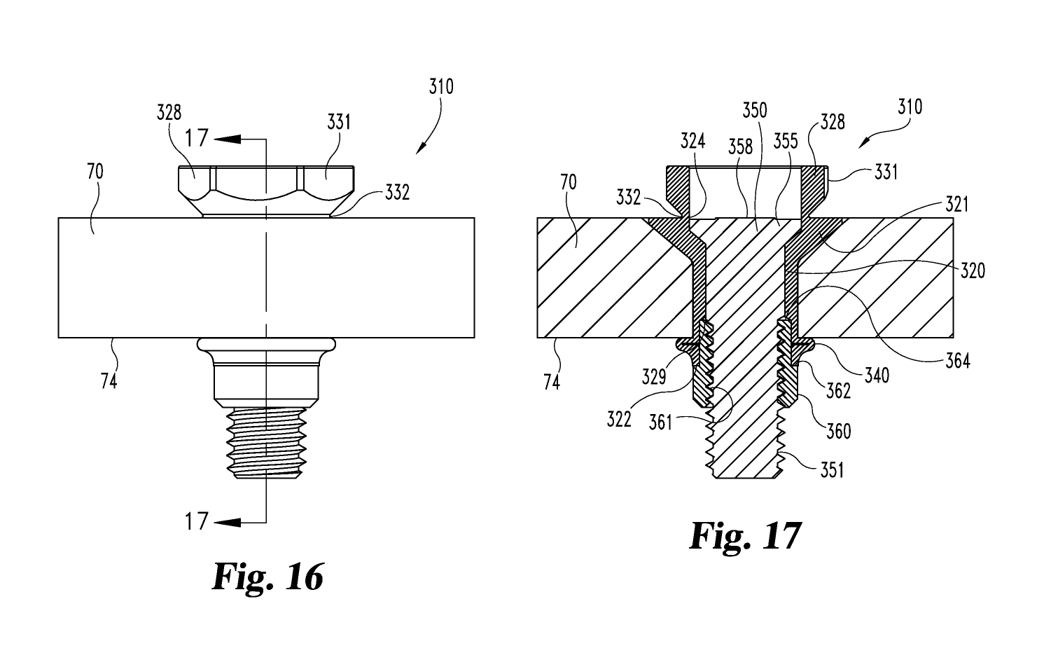

Referring now to FIGS. 16 and 17, blind fastener 310 is illustrated including body 320, core bolt 350 and nut 360. Core bolt 350 includes enlarged head 355 at one end and externally threaded portion 351 at the opposite end. Enlarged head 355 includes engaging means 358. Engaging means 358 includes any means known to engage and rotate core bolt 350 including but not limited to attachment of a wrenching means by a break groove (not illustrated) or detached or a recessed engaging surface such as a screw or Allen™ recess (not illustrated) or any other means known in the art to secure and rotate core bolt 350. Enlarged head 355 may have a frustoconical shape that is constructed and arranged to fit in a countersunk recess in body 320.

Body 320 includes enlarged head 321, smooth wall bore 324, deformable portion 340, end 322, shoulder 329 and undercut 332. Enlarged head 321 may have a frustoconical shape that is constructed and arranged to correspond to a countersink shape in work piece 70. Nut 360 includes internally threaded portion 361, end 364 and shoulder 362. Nut 360 is positioned on core bolt 350 with internally threaded portion 361 threadingly engaged with externally threaded portion 351 with shoulder 362 abutting end 322 of body 320.

Before installation, deformable portion 340 may be initially substantially cylindrical in shape and substantially conforms to the outer diameter of the rest of body 320 with end 322 abutting shoulder 362. Blind fastener 310 is seated by securing the relative position of body 320 by grasping wrenching surfaces 331 then rotating core bolt 350 via engaging means 358 to draw nut 360 up externally threaded portion 351. This compresses deformable portion 340 and eventually causes deformable portion 340 to buckle and fold (or bulb) to form the illustrated blind side clamping surface against blind side surface 74. Installation of blind fastener 310 is complete when end 364 abuts shoulder 329 thereby terminating any additional deformation of deformable portion 340. Once end 364 and shoulder 329 abut, no further longitudinal movement of nut 360 with respect to either core bolt 350 or body 320 is possible. This can be detected by any known means, including, but not limited to a measurement of applied torque or fracturing a frangible member coupled to engaging means 358 (which indicates that blind fastener 310 is seated).

Next, the installed seated torque may optionally be tested by engaging wrenching surface 331 and applying torque until either break groove 332 fractures or fastener 310 rotates in the aperture. Similar to break groove 32, break groove 332 may be constructed and arranged to fracture upon application of a specified fracturing torque equal to the sum of the minimum installed seated torque for the intended application and the manufacturing failure toward tolerance determined by methods of manufacturing fastener 310. If fastener 310 rotates while attempting to fracture break groove 332, then the application specified minimum installed seated torque may not have been achieved indicating that the seated fastener 310 should be removed and replaced.

Undercut 332 is located at the base of extension 328 between wrenching surfaces 331 and enlarged head 321. Undercut 332 may be constructed and arranged in the same way described above with regard to undercut 32 to permit machining out the core of extension 328.

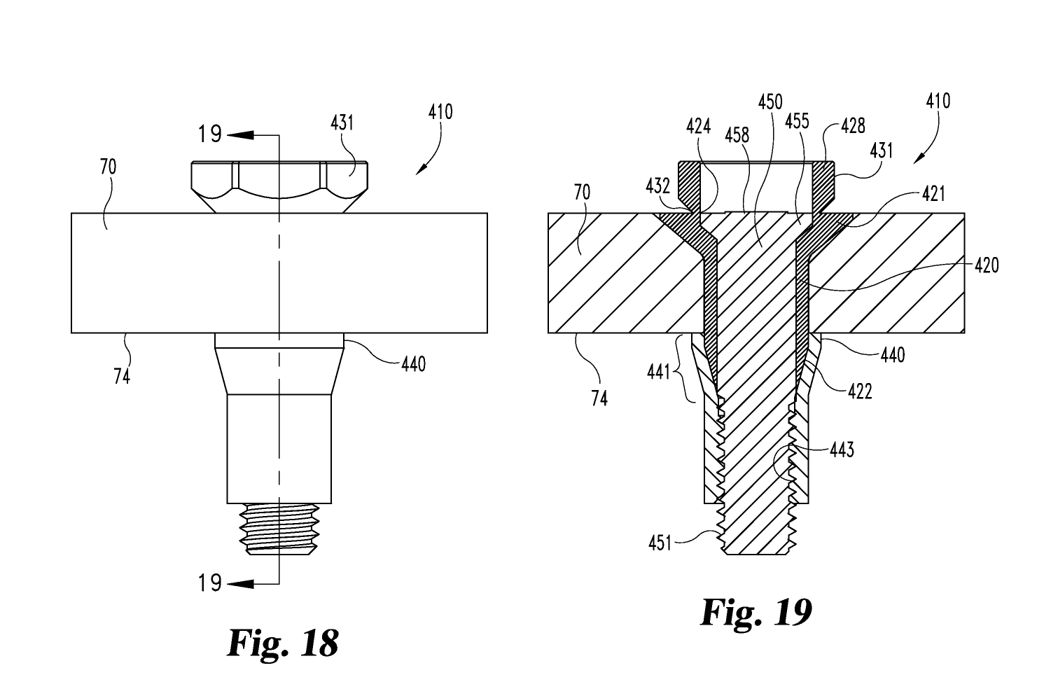

Referring now to FIGS. 18-19, blind fastener 410 is illustrated including body 420, deformable sleeve 440 and core bolt 450. Core bolt 450 includes enlarged head 455 at one end and externally threaded portion 451 at the opposite end. Enlarged head 455 includes engaging means 458. Engaging means 458 may include any means known to engage and rotate core bolt 450 including but not limited to attachment of a wrenching means by a break groove (not illustrated) or detached or a recessed engaging surface such as a screw or Allen™ recess (not illustrated) or any other means known in the art to secure and rotate core bolt 450. Enlarged head 455 may have a frustoconical shape that is constructed and arranged to fit in a countersink recess in body 420.

Body 420 includes enlarged head 421, conical nose 422, smooth wall bore 424 and extension 428 extending from enlarged head 421 with wrenching surface 431 on extension 428 with undercut 432 positioned between wrenching surface 431 and enlarged head 421. Enlarged head 421 may have a frustoconical shape that is constructed and arranged to correspond to a countersink shape. Deformable sleeve 440 includes deformable portion 441 and internally threaded portion 443 that is threadingly engaged with externally threaded portion 451.

Blind fastener 410 is installed by securing the relative position of body 420 by grasping wrenching surface 431 then rotating core bolt 450 via engaging means 458 to draw deformable sleeve 440 up conical nose 422 into abutment with blind side surface 74 to complete seating blind fastener 410. Once complete seating is indicated by other means (not illustrated) for example fracturing of a break groove that is part of engaging means 458, the installed seated torque may optionally be tested by engaging wrenching surface 431 and applying torque until either break groove 432 fractures or fastener 410 rotates in the aperture.

Once again break groove 432 may be constructed and arranged to fracture upon application of a specified fracturing torque which is equal to the sum of the minimum installed seated torque for the intended application and the manufacturing failure torque tolerance determined by the method of manufacturing a particular fastener 410. If fastener 410 rotates while attempting to fracture break groove 432 then the application specified minimum installed seated torque may not have been achieved indicating that seated fastener 410 should be removed and replaced.

Fracturing break groove 32, 132, 232, 332 or 432 on an installed fastener 10, 110, 210, 310 or 410 can be used to provide a positive confirmation that the application specified minimum installed seated torque is achieved by fastener 10, 110, 210, 310 or 410.

Undercut 432 is located at the base of extension 428 between wrenching surfaces 431 and enlarged head 421. Undercut 432 may be constructed and arranged in the same way described above with regard to undercut 32 to permit machining out the core of extension 428.

While the disclosure has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

We claim:

1. A method of installing a fastener through an aperture in a work piece having an accessible side and a blind side, wherein the fastener includes a core bolt, a clamp portion and a body that includes an extension that extends from the body, the method comprising:
inserting, from the accessible side, the fastener into the aperture until the clamp portion is located on the blind side;
engaging a wrenching surface on the extension with a wrenching means to secure a rotational position of the body;
rotating the core bolt with respect to the body to deform the clamp portion to form an enlarged clamp surface against the blind side to seat the fastener in the aperture; and
machining through a top surface of the fastener along a longitudinal axis of the core bolt and the extension until intersecting an undercut between the extension and an upper surface of a head of the body thereby separating the extension from the body.

2. The method of claim 1, further comprising;
machining the body to produce a finished surface substantially flush with a work piece surface.

3. The method of claim 1, further comprising:
using a flat-bottom cutting tool to machine through the top surface along the longitudinal axis of the core bolt.

4. The method of claim 1, wherein a bore of the extension is internally threaded.

5. The method of claim 1, wherein a bore of the extension is substantially smooth.

6. The method of claim 5, wherein the bore of the extension is substantially smooth in a region proximate to the undercut.

7. The method of claim 1, wherein, when machining through the top surface of the fastener until intersecting the undercut, the machining removes material from both the core bolt and the extension.

8. The method of claim 1, wherein machining through the top surface of the fastener until intersecting the undercut forms a remainder portion of the extension that defines a centrally located hole.

9. The method of claim 1, wherein a cutting tool is used to machine through the top surface of the fastener until intersecting the undercut, wherein the cutting tool has an outer diameter that is larger than a minimum diameter of the undercut.

10. A method of dressing an installed fastener, the method comprising:
machining through a top surface of the fastener along a longitudinal axis of a core bolt of the fastener and an extension that extends from a body of the fastener until intersecting an undercut between the extension and an upper surface of a head of a body of the fastener thereby separating the extension from the body.

11. The method of claim 10, further comprising:
machining the body to produce a finished surface on the body substantially flush with a work piece surface.

12. The method of claim 10, further comprising:
using a flat-bottom cutting tool to machine through the top surface along the longitudinal axis of the core bolt.

13. The method of claim 12, wherein the flat-bottom cutting tool has an outer diameter that is larger than a minimum diameter of the undercut.

14. The method of claim 10, wherein a bore of the extension is internally threaded.

15. The method of claim 10, wherein a bore of the extension is substantially smooth.

16. The method of claim 15, wherein the bore of the extension is substantially smooth in a region proximate to the undercut.

17. The method of claim 10, wherein the extension includes a wrenching surface.

18. The method of claim 10, wherein, when machining through the top surface of the fastener until intersecting the undercut, the machining removes material from both the core bolt and the extension.

19. The method of claim 10, wherein machining through the top surface of the fastener until intersecting the undercut forms a remainder portion of the extension that defines a centrally located hole.

20. The method of claim 10, wherein a cutting tool is used to machine through the top surface of the fastener until intersecting the undercut, wherein the cutting tool has an outer diameter that is larger than a minimum diameter of the undercut.
